(19) United States
(12) Patent Application Publication
(10) Pub. No.: US 2007/0241063 A1
(43) Pub. Date: Oct. 18, 2007

(54) Process for treating water using atomized ferrous powders containing 0.25 to 4 wt% carbon and 1 to 6 wt% oxygen

(75) Inventors: Sylvain St-Laurent, Quebec (CA); Benoit Laplante, Quebec (CA)

Correspondence Address: FITZPATRICK CELLA HARPER & SCINTO, 30 ROCKEFELLER PLAZA, NEW YORK, NY, 10112, US

(73) Assignee: Quebec Metal Powders Ltd., Tracy (CA)

(21) Appl. No.: 11/407,342

(22) Filed: Apr. 18, 2006

(51) Int. Cl. C02F 1/72

(52) U.S. Cl. 210/758

(57) ABSTRACT

A process for treating contaminated water in which water contaminated with a volatile organic compound is placed within a volume of iron powder granules which have been water atomized by striking a stream of molten iron with water jets and drying the resulting iron powder. The iron powder granules contain iron, carbon and oxygen, wherein carbon is contained from 0.25 to 4 wt. % and oxygen is contained from 1 to 6 wt. %. The contaminated water is passed through or contacts the iron powder granules, whereby the contaminant is remediated.

### BACKGROUND OF THE INVENTION

1. Field of the Invention

The invention relates to a novel granular iron powder that can be used as a reactive media for, e.g., in situ remediation of contaminated ground-water or of a contaminant plume. The iron powder is used in one technique, among others, in a technique called permeable reactive barrier (PRB) that destroys dissolved volatile organic compounds, including common chlorinated solvents such as tetrachloroethene (PCE), trichloroethene (TCE), dichloroethenes (DCEs), vinyl chloride (VC) and trichloroethane (TCA) among others. The granular iron powder may also be used above ground for treating contaminants, preferably under low oxygen conditions.

2. Brief Description of the Background Art

Processes of remediating contaminated water are very well-known. Conventional systems for removing contaminants from water pass contaminated water through a body of activated carbon. Activated carbon is highly adsorptive material, whereby the dissolved contaminants are removed from the water and retained in the activated carbon. However, over a period of time, the contaminant builds up in the activated carbon and partially or completely reduces its effectiveness.

The activated carbon that has become saturated with contaminant must be periodically removed and disposed of as a hazardous waste. Alternatively, the saturated activated carbon may be rejuvenated by periodically flushing or otherwise treating (e.g., by heating) to remove or drive off the accumulated contaminated material. When the activated carbon has been rejuvenated it can be re-used. The contaminants however still exist, and must be disposed of.

When contaminants are volatile, they may be removed by air-stripping wherein water is aerated. This cleans the water, but the contaminants still exist and are discharged into the atmosphere. Discharged contaminants must still be collected, for example, by adsorbtion onto activated carbon.

Catalytic oxidation at an elevated temperature effectively breaks down chlorinated contaminants into carbon dioxide and an appropriate chloride but is itself very expensive, and so is typically unacceptable on commercial scale, e.g., for purifying a drinking water supply.

Other technologies such as permeable reactive barrier (PRB) treat dissolved halogenated-organic type contaminants by passing contaminated water over or through a body of iron granules, such as iron filings. In PRB, the reactive material, typically granular iron optionally mixed with sand and other materials, is placed below ground such that it intercepts the contaminated groundwater or the contaminant plume path.

As the contaminated groundwater or plume flows though the iron PRB, under natural flow conditions, reactions takes place such as the volatile organic compounds (VOCs) are degraded to nontoxic end products such as ethane, ethane, methane and chloride ions. Prolonged proximity to the iron, especially under strictly anoxic conditions, causes a breakdown reaction into safer, less hazardous materials.

One disadvantage of these “metals” systems is that substantial periods of time, and/or substantial quantities of the metals are required. Additionally, the system can be expensive, not only as regards providing the metals, but also for providing a sufficient residence time of the water within the body of metals, as well as maintaining any further requirements for optimal conditions of pH level, temperature, oxidizing/reducing conditions, etc, throughout that residence time.

Some PRB methods include forming ferrites by neutralizing Fe²⁺ or Fe³⁺ with alkali and oxidizing the neutralized Fe into spinel ferrite, thereby allowing heavy metals to be incorporated or adsorbed into crystals of the thus formed spinel ferrite. It is also known that some heavy metals are incorporated or adsorbed into crystals of iron oxide hydroxide such as α, γor Δ-FeOOH (“Treatment of heavy metal-containing waste water by ferrite method” in “NEC Technical Report”, Vol. 37, No. 9/1984; and Japanese Patent Application Laid-Open Nos. 50-36370, 50-133654 and 50-154164).

Japanese Patent Publication No. 52-45665 teaches blending iron particles in a heavy metal ion-containing solution having a pH of about 5 to 6 to precipitate ferric hydroxide which is then converted into goethite or lepidocrocite with the increase of pH value, thus coprecipitating the heavy metals and adsorbing the heavy metals into the iron particles.

Japanese Patent Publication No. 54-11614 shows oxidizing a heavy metal chelate complex-containing solution having a pH of 2 to 6, with iron particles to increase its pH value of the solution, and adsorb the heavy metals on the surface of the iron particles Japanese Patent Application Laid-Open No. 57-7795 teaches adding iron particles to an iron cyanide complex-containing solution having a pH less than 5 to dissolve a part of the iron particles and adsorb the iron cyanide complex.

Japanese Patent Application Laid-Open No. 10-71386 teaches drilling a bore in contaminated soil, blowing compressed air and iron particles into the bore to form a dispersion layer containing the iron particles, and contacting the iron particles in the dispersion layer with the ground water to render harmful substances contained in the soil harmless.

Japanese Patent Application Laid-Open No. 11-235577 teaches mixing, in contaminated soil containing organohalogen compounds with iron particles containing not less than 0.1% by weight of carbon, which are obtained by subjecting raw sponge ore-reduced iron particles to reduction-refining, sintering, pulverization and screening.

Japanese Patent Application Laid-Open No. 11-253908 describes uniformly kneading PCB with metal particles and then heating the obtained admixed material to at least 250° C. in order to form a metal chloride.

Japanese Patent Application Laid-Open No. 2000-5740 describes rendering harmless organohalogen compounds contained in soil using copper-containing iron particles obtained by subjecting raw sponge ore-reduced iron particles to reduction-refining, sintering, pulverization and screening.

Japanese Patent Application Laid-Open No. 2000-225385 teaches subjecting halogenated hydrocarbons to reduction-dehalogenation by chemical reaction with a reducing metal in the presence of amines that accelerate the dehalogenation reaction.

Japanese Patent Application Laid-Open No. 2000-237768 shows contacting organohalogen compounds with iron-based metals in the form of metal fibers having a large fiber diameter.

Japanese Patent Application Laid-Open No. 2000-334063 describes contacting dioxins at a temperature lower than 100° C. with an aqueous hydrochloric acid solution containing mill scale produced from producting hot-rolled steel plate to degrade the dioxins.

Japanese Patent Application Laid-Open No. 2001-38341 teaches a soil-purifying agent composed of a water suspension containing iron particles having an average particle diameter of 1 to 500 μm.

Japanese Patent Application Laid-Open No. 2001-113261 shows contacting dioxin-contaminated soil with an aqueous hydrochloric acid solution containing an iron compound to degrade the dioxins.

Japanese Patent Application Laid-Open No. 2001-198567 teaches treating a water suspension with spherical iron particles having an average particle diameter of less than 10 μm.

Japanese Patent Application Laid-Open No. 2002-161263 teaches decomposing organohalogen compounds using iron particles having at least one of nickel, copper, cobalt or molybdenum partly adhered to their surface, with the remaining surface area being covered with iron oxide.

“Air Oxidation of Iron Powder Dispersed in Aqueous Solution of Sodium Hydroxide”, Bull. Inst. Chem. Res. Kyoto Univ., Vol. 71, No. 2 (1993) describes that a spinel compound is produced from iron particles through dissolution by pH adjustment with added alkali, heating and forced oxidation.

U.S. Pat. No. 4,382,865 relates to treating effluent created during the manufacture of halogenated pesticides by passing the effluent water stream containing the waste material over a combination of metals to break down the halogenated contaminant.

U.S. Pat. No. 5,266,213 relates to treatment of groundwater in situ, or in an enclosed tank, to remove toxic or carcinogenic industrial solvents such as carbon tetrachloride, trichloroethane, tetrachloroethylene, PCB, and chloroform, under highly reducing conditions. The contaminated groundwater is fed through a trench containing a metal such as iron filings, which degrades the contaminant by hydrolysis under lowered Eh of −100 or −200 mV.

U.S. Pat. No. 5,534,154 relates to cleaning groundwater in its native aquifer, or of factory discharge effluent containing halogenated hydrocarbons is passed in the absence of oxygen through a permeable mixture of activated carbon and iron fillings. When the mixture is brought to a negative Eh voltage, the metal causes the contaminants to undergo chemical breakdown. Activated carbon is used to increase the residence time adjacent the iron.

U.S. Pat. No. 6,287,472 teaches that coating the iron particles with a small amounts of nickel improves contaminant degradation rates and lower production of halogenated organic compounds. Additionally, nickel coated iron particles avoids the need to exclude oxygen from the body of iron particles so that surface water and industrial waste streams can be treated, in addition to oxygen-free groundwater.

U.S. Pat. No. 7,022,256 relates to use of iron particles for purifying soil or ground water by decomposing or insolubilizing harmful substances such as organohalogen compounds and/or heavy metals, cyanogen, etc. contained therein. The iron particles are a mixed phase of α-Fe phase and Fe₃O₄ phase, having a BET specific surface area of 5 to 60 m²/g, an Fe content of not less than 75% by weight based on the weight of the iron particles and a sulfur content of not less than 1,000 ppm.

Another commercially available granular iron that can be used in groundwater remediation is H-200 produced by Hoaganaes Corporation (USA). This grade is produced via the sponge process used to produced feedstock for the PM industry. In this process, magnetite iron ore is reduced to pure iron in a high temperature, solid-state reduction tunnel kiln. The product resulting from that reduction process is then crushed and sieved. This grade contains typically around 0.25% carbon and 1.2% oxygen. The size of particles are mainly below 100 mesh (<150 μm). The typical size distribution is ˜5% between 100 and 140 mesh (105 to 150 μm), ˜40% between 140 and 230 mesh (63 to 105 μm), 25% between 230 and 325 mesh (45 to 63 μm) and ˜30% below 325 mesh (<45 μm). The D50 as measured by laser diffraction is ˜80-90 μm.

### BRIEF DESCRIPTION OF THE DRAWINGS

FIG. 1: Is a schematic of the apparatus used in bench-scale testing herein

FIG. 2: Shows CT concentration profiles along the columns using QMP H2Omet™ 57.

FIG. 3: Shows TCM concentration profiles along the columns using QMP H2Omet™ 57.

FIG. 4: Shows DCM concentration profiles along the columns using QMP H2Omet™ 57.

FIG. 5: Shows CFC-113 concentration profiles along the columns using QMP H2Omet™ 57.

FIG. 6: Shows CFC-11 concentration profiles along the columns using QMP H2Omet™ 57.

FIG. 7: Shows trichloroethene (TCE) and cis 1,2-dichloroethene (cDCE) concentration profiles versus residence time (solid line) along the bench-scale test column using QMP H2Omet™ 58.

FIG. 8: Shows tetrachloroethene (PCE), trans 1,2-dichloroethene (tDCE) and 1,1-dichloroethene (11DCE) versus residence time (solid line) along the bench-scale test column using QMP H2Omet™ 58.

FIG. 9: Shows vinyl chloride (VC) concentration profiles versus residence time (solid line) along the bench-scale test column using H2Omet™ iron.

FIG. 10: Shows molar conversions obtained from the least squares best fits of the first-order kinetic model to the bench-scale test column data using H2Omet™ 58 iron.

### DETAILED DESCRIPTION OF THE INVENTION

Methods of remediating heavy metals using iron particles generally reduce the valence of heavy metals and render the metals into harmless or less harmful stabilized form. Some heavy metals are incorporated or adsorbed into crystals of goethite or spinel ferrite formed by dissolution of a small amount of iron particles in an acid region. Thus, in the relevant above-described conventional techniques, the iron particles generally exhibit either reduction activity or adsorptivity.

Although some of the conventional techniques describe the dissolution effect of the iron particles, most relate to a mechanism in which the iron particles are converted via elution thereof in an acid region into goethite, lepidocrocite or magnetite to incorporate heavy metals into crystals thereof. Other mechanisms incluse those wherein Fe²⁺ or Fe³⁺ is dissolved and formed into spinel ferrite while incorporating heavy metals thereinto.

In the presence of granular iron, hazardous dissolved chemicals known as dissolved halogenated hydrocarbons or halogenated solvents preferably degrade to nontoxic end products. This abiotic process involves corrosion (oxidation) of zero-valent iron and reduction of dissolved halogenated hydrocarbons. The process induces highly reducing conditions that cause substitution of chlorine atoms by hydrogen in the structure of halogenated hydrocarbons.

There are two competing pathways for dechlorination of halogenated ethenes in iron systems; β-elimination and hydrogenolysis (Eykholt, 1998 and Arnold and Roberts, 1999).

The β-elimination pathway dominates the reaction and produces chloroacetylene intermediates, which are unstable and rapidly reduced to ethene (Roberts et al., 1996 and Sivavec et al., 1997). The hydrogenolysis pathway is a slower reaction during which lesser-halogenated intermediates are produced and subsequently degraded.

As a consequence of these reactions, granular iron has been placed below the ground surface to promote the “in-situ” destruction of these contaminants in groundwater. This technology, sometimes referred to as iron permeable reactive barrier (iron PRB) technology is accepted as a viable alternative for the remediation of halogenated solvents in groundwater, with over 100 applications around the globe and more than 8 years track record of successful field performance. Iron PRBs are remediating contaminated groundwater throughout the United States, Europe, Japan and Australia.

As discussed, iron PRB systems completely destroy volatile organic compounds (VOCs), as opposed to air-stripping or pump-and-treat (P&T) where contaminants are simply transferred to the atmosphere, or to granular activated carbon which requires further disposal or regeneration. Iron PRB technology is applicable under most geochemical conditions and does not require reapplication, resulting in a predictable, reliable, long-term treatment solution.

The granular iron used in iron PRB technology to date generally comprises a mixture of ductile and cast iron cuttings and borings that are obtained by manufacturers from a number of primary industries that use iron in the production of automotive and related industrial parts. To create the end product used in PRB applications, a number of these “feedstocks” are typically mixed together, put through a rotary kiln at several hundred degrees Celsius in proprietary gas mixtures, cooled by a variety of methods, and then grounded and sieved to a specific grain size range.

Conventional granular iron used in iron PRB contain trace metal(s) including about 2 to 3% silicon, 2 to 3% carbon, 0.3 to 0.5% manganese, 0.1 to 0.2% copper, and varying amounts of other metals in the <0.1% (typically 100s of ppm) range. Under some conditions, certain of these metals may leach from the iron into groundwater, negating the iron's beneficial effect.

Also granular iron conventionally utilized in iron PRB contains carbon present as both flake and rosette-type graphite structures, as well as ferrite and iron carbide. The material has a thick outer layer of iron oxide, which sometimes includes considerable amounts of inorganic carbon. The materials physically exhibit a wide range of flake-like morphologies, which may represent a limitation to their placement below ground in certain situations because of handling issues.

Rather than making use of cast iron cuttings and spoils from other industries, the subject invention utilizes iron particles prepared specifically for iron PRB applications so as to offer enhanced degradation capabilities and other advantages relative to the conventional granular iron described above. In particular, the granular iron described in this invention is produced by a unique water granulation/atomization process used in the powder metallurgy (PM) industry. (As used herein, “granulation” and “atomization” are interchangeable.) The iron of the invention offers greatly enhanced degradation capabilities of VOCs and other advantages over conventional granular iron used in PRB technology.

In the water atomization process, high purity liquid iron produced from a smelter typically containing between 2 to 4% carbon is transferred in a tundish and granulated by striking a stream of the molten metal with medium to high-pressure water jets in a dedicated tank. The slurry resulting from that process is then dried to obtain as-atomized iron powder with a size varying typically from 200 mesh (75 μm) to 6 mesh (3.2 mm). The size as well as the final level of carbon and oxygen can be adjusted through the granulation parameters which are but not limited to: water pressure, water flow rate, liquid iron mass flow rate, liquid iron temperature, water temperature, water atomization jet geometry, etc.

The iron granules produced according to the present invention may be subsequently sieved and/or ground to the desired size distribution in order to achieve particular properties such as the bulk density (defined as the weight of a given volume of granular iron powder or sometimes as the volume occupied by a given mass of granular iron powder) or permeability (defined as the rate of flow of liquid through the granular iron powder), among others.

The present inventors have learned that unexpectedly, and despite the relatively spherical-like shape of iron particles obtained by the water atomization processing of the present invention described above, the surface area to volume ratio of the resulting iron granules remains high, providing particularly high reactivity and high VOC degradation rates.

The chemistry of the granular iron produced by the described method typically contains between 0.25 to 4 wt. % carbon, preferably 1 to 4 and more preferably between 2.5 to 3.5 wt. % carbon. The oxygen content of the as-granulated powder varies typically between 1 to 6 wt. % depending on the size distribution of the product, preferably 2.5 to 6, more preferably 2.5 to 3.5 wt. % oxygen. The oxygen content generally increases when particle size is decreased.

The resulting iron granules or powders may also be preferentially passed through decarburizing furnaces where it is exposed to controlled heat in a reducing atmosphere in order to lower the amount of carbon and/or oxygen in the powder to desired values. After decarburization is completed, the powder is milled to get the final product. Further extreme processing is not normally required for iron powder used in typical PRB applications.

The inventors have also learned these water atomization, sieving and grinding processes provide more consistent and uniform spherical-like shape, which facilitates the handling and placement of iron within walls in the ground. Additionally, these material handling processes may be utilized to provide a size distribution particularly to provide good PRB permeability tailored for the specific contaminant and ground water or contaminant plume rate intended to be remediated.

Three preferred embodiments of a high purity granulated iron produced via the described method and that are particularly suited for PRB processes are H2Omet™ 56, 57 and 58 (Quebec Metal Powders, Quebec, Canada). The typical size distribution and chemistry of these three grades is given in Table 1. H2Omet™ 57 corresponds to the as-granulated product that is sieved in order to remove particles larger than 5 mm. H2Omet™ 58 is the oversize portion of the as-granulated iron powder sieved with a screen equivalent to 70 to 20 mesh. H2Omet™ 56 is the downsize or fine portion resulting from that sieving operation. Both H2Omet™ 56 and 58 are also sieved to eliminate particles larger than 5 mm. For all H2Omet™ products, the carbon content is around 3.2%. The oxygen content varies depending on the size distribution as shown.

TABLE 1

| | | | As-atomized Iron powder | | |
|---|---|---|---|---|---|
| | Sieve | Size, mm | H2Omet ™ 56 | H2Omet ™ 57 | H2Omet ™ 58 |
| Size | +6 | | 100.0 | | 100.0 |
| Distribution | −6 + 12 | 3.24 | 100.0 | 100.0 | 99.8 |
| % Passing | −12 + 14 | 1.68 | 100.0 | 99.5 | 96.8 |
| | −14 + 30 | 1.42 | 100.0 | 98.5 | 93.4 |
| | −30 + 50 | 0.60 | 100.0 | 80.1 | 40.7 |
| | −50 + 100 | 0.30 | 86.0 | 52.1 | 3.6 |
| | −100 + 200 | 0.15 | 44.0 | 26.8 | 1.8 |
| | −200 | 0.074 | 18.3 | 10.0 | 1.1 |
| Chemistry | % C | | 3.1 | 3.3 | 3.3 |
| | % O | | 4.3 | 2.6 | 1.1 |
| | % S | | 0.010 | 0.008 | 0.010 |

Use of powders provided by water atomization processing results in significant improvement in the degradation rates of dissolved halogenated contaminants. Halogenated volatile organic compound degradation observed in groundwater in contact with granular iron is typically described using first-order kinetics:

$$\begin{matrix}C = {C}_{o} {ⅇ}^{- k t} \\ or & ( 1 ) \\ ln ( \frac{C}{{C}_{o}} ) = - k t & ( 2 )\end{matrix}$$

where:

C=VOC concentration in solution at time (t),

Co=VOC concentration of the influent solution,

k=first-order rate constant,

t=time (t).

The time at which the initial concentration declines by one-half, (C/Co=0.5), is the half-life. This half-life value is often used as an indicator of the reactivity or performance of the iron in question. Table 2 compares the reactivity of the present invention relative to PRB processes using conventionally sourced granular iron, and shows the enhanced reactivity of the subject material when it is exposed to several common dissolved halogenated contaminants.

TABLE 2

| | | H2Omet |
|---|---|---|
| | Conventional Iron | 58 |
| Dissolved Halogenated | Half-Life | Half-Life |
| Contaminant | (hr) | (hr) |
| Tetrachlorethene | 6.5 | 2.5 |
| Trichloroethene | 3.1 | 1.7 |
| Cis-1,dichloroethene | 9.0 | 0.9 |
| 1,1-dichloroethene | 5.8 | 0.4 |
| Vinyl Chloride | 3.7 | 0.5 |

### WORKING EXAMPLES

Column tests were conducted using Quebec Metal Powders H2Omet™ 57 iron and commercial U.S. iron source (PL) to evaluate their ability to degrade chlorinated volatile organic compounds (VOCs).

Material and Methods

H2Omet™ 57 is a granular iron atomized (granulated) and dried as described in the previous section. The size distribution and the typical chemistry of that powder is given in Table 2. The commercial iron sources used in that study comprises a mixture of ductile and cast iron cuttings and borings that are obtained from a number of primary industries that use iron in the production of automotive and related industrial parts. To create the end product to be used in PRB applications, a number of these “feed stocks” are mixed together, put through a rotary kiln at several hundred degrees Fahrenheit in proprietary gas mixtures, cooled by a variety of methods, milled and sorted to a specific grain size range.

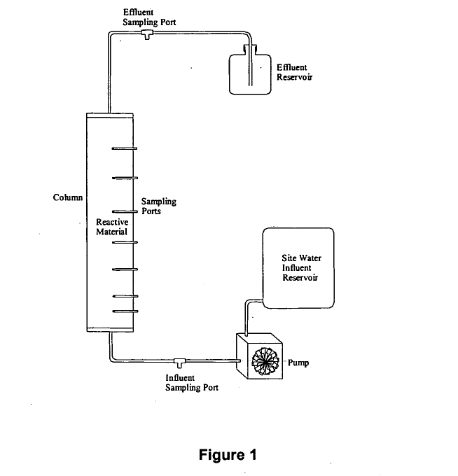

The columns were constructed of Plexiglas™ with a length of 1.6 ft (50 cm) and an internal diameter of 1.5 in (3.8 cm) (FIG. 1). Seven sampling ports were positioned along the length at distances of 0.08, 0.16, 0.33, 0.50, 0.66, 1.0, and 1.3 ft (2.5, 5, 10, 15, 20, 30, and 40 cm) from the inlet end. The columns also allowed for the collection of samples from the influent (0 cm) and effluent (50 cm) lines.

Each sampling port consisted of a nylon Swagelok fitting ( 1/16 in) tapped into the side of the columns, with a syringe needle (16G) secured by the fitting. Glass wool was placed in the needle to exclude the iron particles. The sampling ports allowed samples to be collected along the central axis of the column. Each sample port was fitted with a Luer-Lok™ fitting, such that a glass syringe could be attached to the port to collect a sample. When not in operation the ports were sealed by Luer-Lok™ plugs. To assure a homogeneous mixture, aliquots of iron mixture were packed vertically in lift sections within the column. Values of bulk density, porosity, and pore volume were determined by weight (Table 4). The column experiments were performed at room temperature (25° C.).

The columns received a variety of groundwater chemistries, as described above. An Ismatec™ IPN pump was used to feed the site water from a collapsible Teflon® bag to the influent end of both columns. The pump tubing consisted of Viton®, and all the other tubing was Teflon® (⅛-inch OD× 1/16-inch ID).

Analytical Methods

Organic Analyses

For the less volatile compounds, the TCE was extracted from the water sample within the glass sample bottle using pentane with an internal standard of 1,2-dibromoethane, at a water to pentane ratio of 2.0 to 2.0 mL. The sample bottles were placed on a rotary shaker for 10 minutes to allow equilibration between the water and the pentane phases, then the pentane phase was transferred to an autosampler bottle. Using a Hewlett Packard 7673 autosampler, a 1.0 μL aliquot of pentane with internal standard was automatically injected directly into a Hewlett Packard 5890 Series II gas chromatograph. The chromatograph was equipped with a Ni⁶³ electron capture detector (ECD) and DB-624 megabore capillary column (30 m×0.538 mm ID, film thickness 3 μm). The gas chromatograph had an initial temperature of 50° C., with a temperature time program of 15° C./minute reaching a final temperature of 150° C. The detector temperature was 300° C. The carrier gas was helium and makeup gas was 5% methane and 95% argon, with a flow rate of 30 mL/min.

For the more volatile compounds such as the DCE isomers and VC, 4.0 mL samples were collected in glass on glass syringes and placed in 10 mL Teflon® faced septa crimp cap vials, creating a headspace with a ratio of 6.0 mL headspace to 4.0 mL aqueous sample. The samples were placed on a rotary shaker for 15 minutes to allow equilibration between the water and gas phase. Using a Hewlett Packard 7694 headspace auto sampler, a 1 mL stainless steel sample loop injected the samples directly onto a Hewlett Packard 5890 Series II gas chromatograph. The chromatograph was equipped with a HNU photoionization detector (PID) with a bulb ionization potential of 10.2 eV. The gas chromatograph was fitted with a fused silica capillary NSW-PLOT column (15 m×0.53 mm ID). The samples were placed in the analyzer oven for 2 minutes at 75° C., and subsequently injected onto the gas chromatograph. The temperature program was 160° C. for 5.5 minutes, then increased at 20° C./min to 200° C. and held for 5.5 minutes. The injector and detector temperatures were 100° C. and 120° C., respectively. The carrier gas was helium with a flow rate of 5.5 mL/min. Data was collected with a Pentium 166 computer using HP-Chemstation Version 5.04.

Method detection limits (MDL) were determined for each compound as the minimum concentration of a substance that can be identified, measured and reported with 99% confidence that the analyte concentration is greater than zero. The MDLs were determined from analysis of samples from a solution matrix containing the analytes of interest. Although MDLs are reported, these values are not subtracted from any reported VOC concentrations. The reason for this is that it indicates that the organic concentrations are approaching or advancing within the column, and is helpful when determining degradation rates. Detection limits for all compounds, as given in Table 5, were determined using the Environmental Protection Agency (EPA) procedure for MDL (US EPA, 1982).

### Example 1

The test objective was to evaluate a shift in CT reaction chemistry previously observed with dry-packed H2Omet™ 57. The column was packed with H2Omet™ 57 material that was soaked in water for 2 weeks. The column set up and the influent water composition were similar to those used in prior tests with the H2Omet™ 57 material (Table 4). The column influent solution was prepared using laboratory grade chemicals to achieve influent concentrations of about 60 mg/L CT, 50 mg/L for CFC-11 and 10 mg/L CFC-113. A background solution of 300 mg/L of CaCO₃ was used.

### Example 2

A two column test (H2Omet™ 57 and PL) was conducted to determine the influence of biodegradable guar slurry used in vertical huydrofracturing PRB installation method on iron reactivity using simulated groundwater. The H2Omet™ 57 and PL materials were mixed with a guar slurry, based on the preparation procedure provided by an injection method contractor, and placed into the columns. The iron/slurry mix formed a gel initially, but within two days the enzyme contained in the slurry caused the cross-linked bonds to break. After breaking, the guar was flushed from the columns, allowing the column test to begin. The columns and iron materials parameters are shown in Table 4. The column influent was a simulated water with the same composition as above.

### Example 3

A two-column test (H2Omet™ 57 and PL) was conducted to determine the influence of site water composition on iron reactivity (groundwater collected at a contaminated site was used). The main VOCs that were detected included about 80 mg/L of CT, 60 mg/L of CFC-11 and 12 mg/L of CFC-113, with smaller amounts of TCM, PCE and TCE. The PL column was packed dry, while the pre-soaked H2Omet™ 57 iron was used in the H2Omet column (Table 3).

TABLE 3

| | | Simulated | | | | | Site | |
|---|---|---|---|---|---|---|---|---|
| | | Groundwater | | | Guar - Simulated | | Groundwater | |
| | | | H2Omet ™ 57 | | Groundwater | | H2Omet ™ 57 | |
| | | H2Omet ™ 57 | Wetted | PL | H2Omet ™ 57 | PL | Wetted | PL |
| Flow Velocity (ft/day) | FV1 | 2.9 | 3.3 | 3.0 | 3.1 | 2.9 | 1.6 | 1.7 |
| | FV2 | 5.3 | 5.4 | 6.8 | | | | |
| Residence Time (hrs) | FV1 | 13.4 | 11.9 | 12.8 | 12.7 | 13.4 | 24.6 | 23.7 |
| | FV2 | 7.2 | 7.3 | 5.6 | | | | |

| | | | | | | | |
|---|---|---|---|---|---|---|---|
| Pore Volume (mL) | 296 | 296 | 290 | 296 | 290 | 296 | 287 |
| Porosity | 0.52 | 0.52 | 0.51 | 0.52 | 0.51 | 0.52 | 0.50 |

Test Results

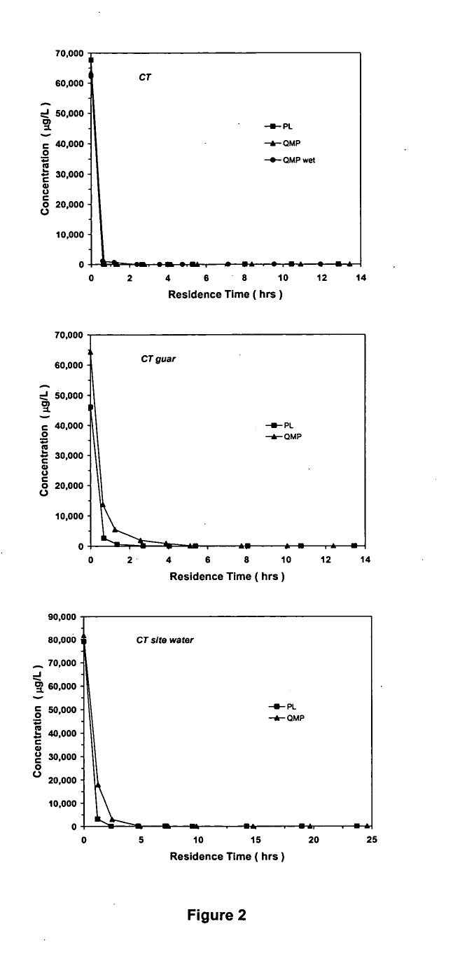

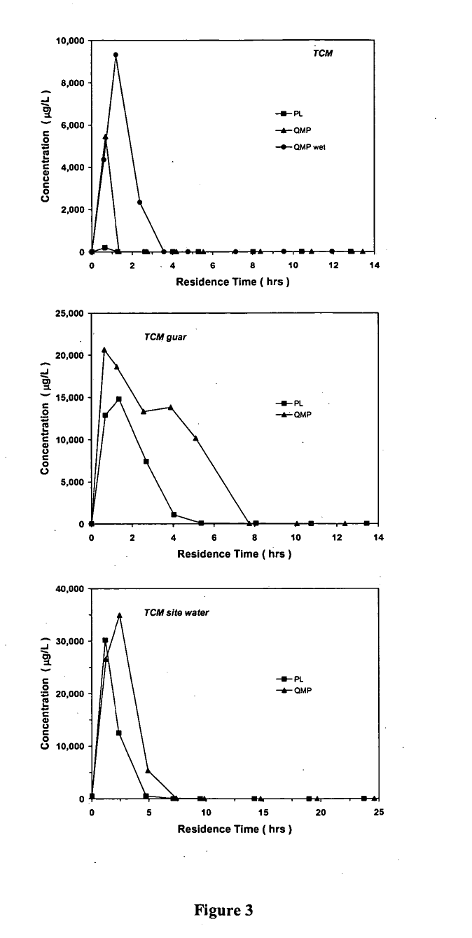

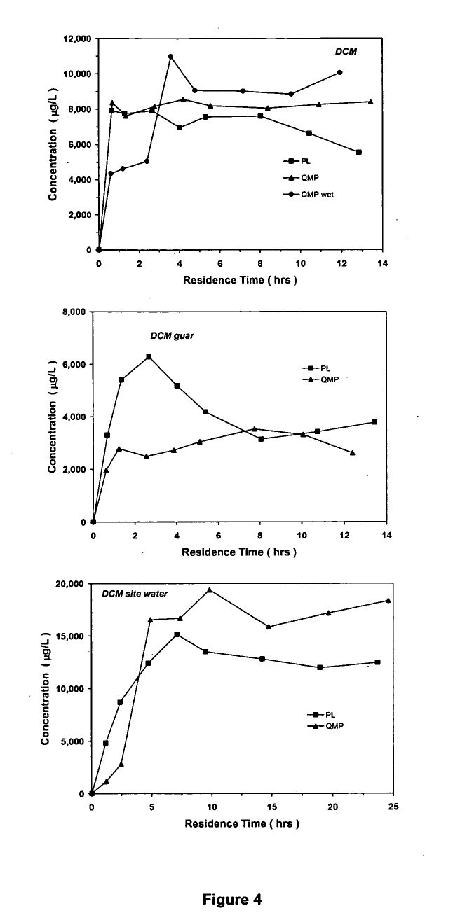

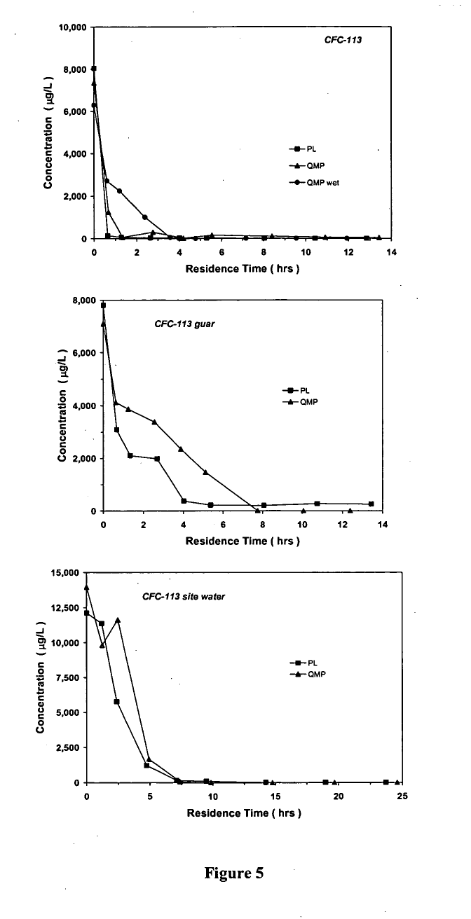

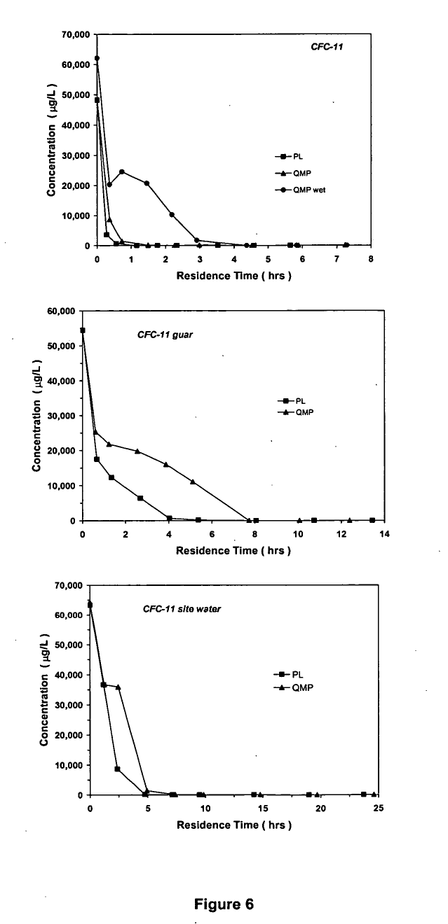

Concentration profiles for the last sampling events are grouped by the type of test and shown in FIGS. 2 through 6. The half-lives determined for the last VOC profiles at steady state are shown in Table 4, along with the molar conversions.

From Table 5, CT half-lives in simulated groundwater were similar for both materials and TCM half-lives showed some variability, but were lowest in the H2Omet™ 57 column with simulated groundwater.

The test results showed the VOC degradation rates for both iron materials were consistently slower (demonstrated by higher half-lives and higher conversion rates from CT to TCM and DCM) in the columns containing guar and those receiving site groundwater, compared to the columns with simulated water only (Table 4). Guar is known to lower reactivity rates, so these results are expected.

The soaking pre-treatment of the H2Omet™ 57 material resulted initially in higher degradation rates, compared to the dry-packed H2Omet™ 57 column. However after the initial 40 pore volumes of flow, a gradual decrease in reactivity with time was observed in the pre-soaked column, whereas this trend was less evident in the dry-packed column. As a result, the VOC half-lives in the pre-soaked column, calculated based on the last VOC profiles at both flow velocities, were higher in the pre-soaked H2Omet™ 57 column, compared to the dry-packed H2Omet™ 57 column (Table 4). Based on these results, it appears that the soaking pre-treatment does not improve the long-term reactivity of H2Omet™ 57 iron.

TABLE 4

| | | Simulated | | | | | Site | |
|---|---|---|---|---|---|---|---|---|
| | | Groundwater^{a} | | | Guar - Simulated | | Water | |
| | | | H2Omet ™ 57 | | Groundwater | | H2Omet ™ 57 | |
| Compounds/ | Influent Conc. | H2Omet ™ | Wetted | PL | H2Omet ™ 57 | PL | Wetted | PL |
| Conversion | (mg/L) | Laboratory Half-Life (hrs) (Correlation Coefficient)/Molar Conversion | | | | | | |
| CT | 50-80 | 0.07 | 0.06 | 0.06 | 0.29 | 0.16 | 0.55 | 0.25 |
| | | (1.0) | (0.999) | (1.0) | (0.997) | (0.999) | (0.999) | (0.939) |
| TCM | — | 0.17 | 1.3 | 0.33 | 2.3 | 1.4 | 1.6 | 1.3 |
| | | (0.993) | (0.846) | (0.923) | (0.894) | (0.917) | (0.815) | (0.957) |
| CT-TCM | — | 95% | 34% | 1.1% | 57% | 57% | 72% | 74% |
| CT-DCM^{b} | — | 23.4% | 9.6% | 19.4% | 5.9% | 12% | 27% | 21% |
| CFC-11 | 30-60 | 0.26 | 0.32 | 0.09 | 1.1 | 0.52 | 2.1 | 1.1 |
| | | (0.997) | (0.767) | (0.999) | (0.766) | (0.973) | (0.914) | (0.966) |
| CFC-113 | 7-10 | 0.16 | 0.53 | 0.10 | 2.3 | 0.75 | 2.4 | 2.0 |
| | | (0.999) | (0.758) | (0.999) | (0.907) | (0.938) | (0.864) | (0.947) |

^{a}Based on profiles obtained at the first flow velocity.
^{b}The amount of DCM created directly from CT and from the generated TCM could not be resolved. The molar conversion is based on the average concentration of the generated DCM in relation to the initial CT concentration.

### Example 4

A column treatability test was undertaken consisting of two columns containing 100% of granular iron obtained from two iron sources: Quebec Metal Powders H2Omet™ 58 and a commercial U.S. source (US) used typically for iron PRB applications. The column and iron material parameters are shown in Table 5. The H2Omet™ 58 is a granular iron produced by atomization, dried and then sieved according to the method described previously. The chemistry and size distribution of the H2Omet™ 58 used in tests are given in Table 2. The commercial iron is identical to the one described in the previous example.

Influent groundwater contained tetrachloroethene (PCE) of about 50 μg/L, TCE of about 130,000 μg/L, cis 1,2-dichloroethene (cDCE) of about 35,000 μg/L, trans-1,2-dichloroethene (tDCE) of about 150 μg/L, 1,1-dichloroethene (11DCE) of about 200 μg/L, VC of about 2,800 μg/L, 1,1,1-trichloroethane (111TCA) of 700 μg/L and trace levels of chloroform (TCM).

Samples for measurement of VOC concentrations along the length of the column were taken approximately every 5 to 9 PVs. Using the distance for each sampling port and flow velocity, the residence time was calculated for each port. The results obtained when steady state conditions were reached are plotted as VOC concentration (μg/L) versus residence time within the column (hrs).

TABLE 5
Materials:

| | | |
|---|---|---|
| Iron Source | US Commercial | H2Omet ™ 58 |
| | Source | |
| Iron Grain Size | 2.0 to 0.25 mm | 1.7 to 0.20 mm |
| | (−8 to +50 mesh) | (−12 to +60 mesh) |
| Iron Surface Area | 1.0 m²/g | — |
| Iron (100%) Hydraulic | 7.1 × 10⁻² cm/sec | 4.6 × 10⁻² cm/sec |
| Conductivity | (201 ft/day) | (131 ft/day) |

Column:

| Test Temperature | 23° C., 73° F. | |
|---|---|---|
| Flow Velocity | 45 cm/day (1.5 ft/day) | 50 cm/day (1.6 ft/day) |
| Residence Time | 27.0 hrs | 24.2 hrs |
| Pore Volume | 327 mL | 298 mL |
| Porosity | 0.57 | 0.52 |
| Bulk Density | 2.94 g/cm³ (183 lb/ft³) | 3.37 g/cm³ (210 lb/ft³) |
| Iron to Volume of | 5.1 g:1 mL | 6.4 g:1 mL |
| Solution Ratio | | |
| Surface Area to Volume | 5.6 m²:1 mL | — |
| of Solution Ratio | | |

Degradation of Volatile Organic Compounds

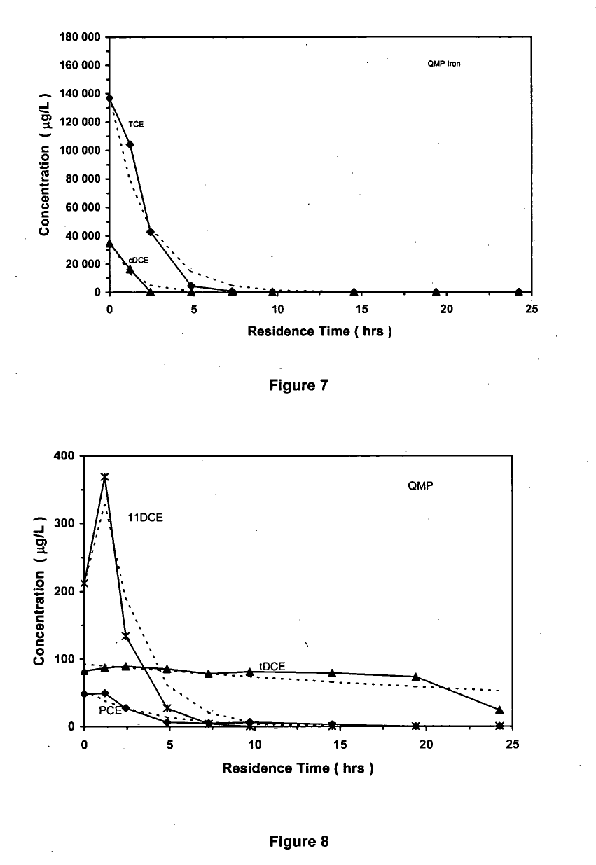

The final steady-state concentration profiles for the H2Omet™ 58 column are shown in FIGS. 7 to 9. In FIGS. 7 to 9, the dotted line represents the least squares best fits of the first-order kinetic model to the data.

### Example 5

At a flow velocity of about 50 cm/day (1.6 ft/day), one PV corresponds to a residence time of about 24.2 hrs. A total of 59.1 PVs of water were passed through the column. The TCE concentration declined from an influent concentration of 136,838 μg/L to 57 μg/L in the column effluent (FIG. 7). The influent cDCE concentration of 34,851 μg/L declined to a non-detectable value within a residence time of 9.7 hrs along the column and for the remainder of the column (FIG. 7).

### Example 6

The PCE concentration declined from an influent concentration of 48 μg/L to a non-detectable value within a residence time of 19.4 hrs along the column (FIG. 8). The tDCE concentration declined from an influent concentration of 82 μg/L to 24 μg/L in the column effluent (FIG. 8). The influent concentration of 11 DCE of 212 μg/L increased to a peak concentration of 369 μg/L due to the dechlorination of TCE, and then declined to a non-detectable value within a residence time of 9.7 hrs in along the column (FIG. 8).

### Example 7

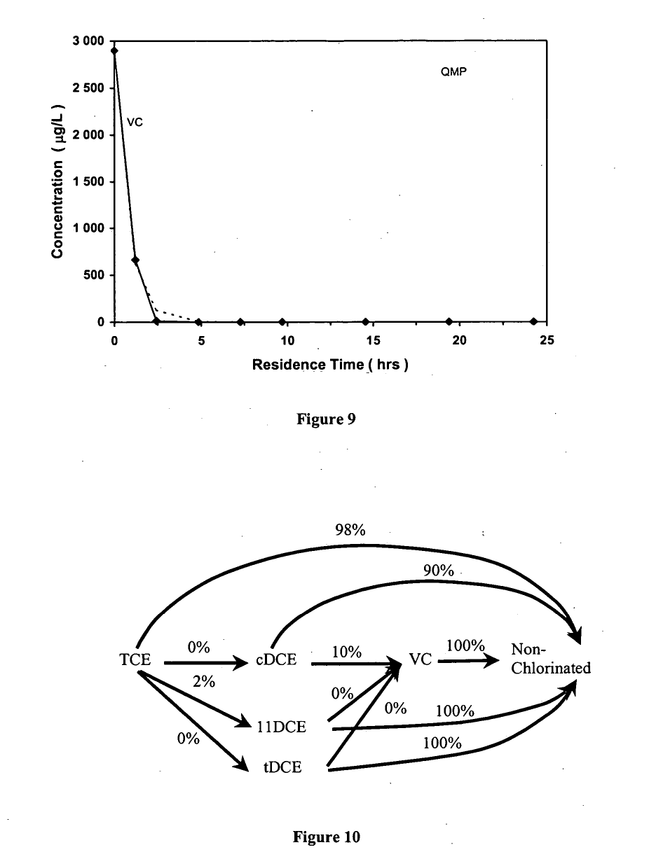

The influent concentration of VC of 2,898 μg/L declined to a non-detectable value within a residence time of 4.8 hrs along the column (FIG. 9). The concentration of 111TCA in the influent of 578 μg/L declined to a non-detectable value within a residence time of 1.2 hrs along the column. A small amount of TCM was detected within the column sampling ports.

### Example 8

The VOC degradation trends observed in groundwater in contact with granular iron were described using a first-order kinetic model. The results from the model include half-lives and molar conversions for all VOCs selected and statistical fit data including coefficient of determination (r²) values. The r² values indicate how well the degradation model represents the experimental data. The half-lives determined for the last VOC profiles at steady state are shown in Table 6. The molar conversions are shown in FIG. 10.

TABLE 6

| | U.S. Commercial Iron | | | H2Omet ™ 58 Iron | | |
|---|---|---|---|---|---|---|
| | | | Coefficient | | | Coefficient |
| Volatile | Influent | | of | Influent | | of |
| Organic | Concentration | Half-Life^{a} | Determination | Concentration | Half-Life^{a} | Determination |
| Compound | (μg/L) | (hr) | (r²) | (μg/L) | (hr) | (r²) |
| PCE | 58 | 6.5 | 0.952 | 48 | 2.5 | 0.912 |
| TCE | 151,646 | 3.1 | 0.977 | 136,838 | 1.7 | 0.967 |
| CDCE | 31,106 | 9.0 | 0.808 | 34,851 | 0.9 | 0.968 |
| TDCE | 88 | ND | — | 82 | ND | — |
| 11DCE | 248 | 5.8 | 0.871 | 212 | 0.4 | 0.871 |
| VC | 2,809 | 3.7 | 0.853 | 2,898 | 0.5 | 0.999 |
| 111TCA | 613 | <0.2^{b} | 1.0 | 578 | <0.1^{b} | 1.0 |

ND = Not determined
^{a}Half-lives are based on the final VOC profile measured in the column test
^{b}Two-point regression

The test results indicate that degradation rates with H2Omet™ 58 for the VOCs present in the site groundwater are higher than those for a commercial granular iron.

Upon comparison of data from the two iron sources, the half-lives for all the compounds in the site groundwater were lower in the H2Omet™ 58 column than the commercial iron source column (Table 6). Moreover, the degradation rates and final contaminant concentration levels obtained were overall surprisingly improved, especially given the relatively high influent VOC concentrations utilized.

1. A process for treating contaminated water, comprising the steps of:
commingling water contaminated with a volatile organic compound with a volume of iron powder granules, the iron powder granules being water atomized by a process comprising granulating liquid iron by striking a stream of molten iron with water jets, and drying the resulting iron powder, said iron powder granules comprising iron, carbon and oxygen, wherein said oxygen is contained in said granules at from 1 to 6 wt. %; and
permitting said contaminated water to pass through said iron powder granules, whereby said contaminant is remediated from said contaminated water.

2. The process according to claim 1, wherein said iron powder granules have an average particle size of from 10 μm to 10 mm.

3. The process according to claim 2, wherein said carbon is contained in said granules at from 0.25 to 4 wt. %.

4. The process according to claim 3, wherein said iron powder granules have an average particle size of from 45 μm to 5 mm.

5. The process according to claim 4, wherein said carbon is contained in said granules at from 1 to 4 wt. %.

6. The process according to claim 5, wherein said oxygen is contained in said granule at from 2.5 to 6 wt. %.

7. The process according to claim 6, wherein said oxygen is contained in said granule at 2.5 to 3.5 wt. %.

8. The process according to claim 7, wherein said iron powder granules have an average particle size of from 100 μm to 5 mm.

9. The process according to any one of claims 5 to 8, wherein dissolved oxygen is removed from said contaminated water.

10. The process according any one of claims 5 to 8, wherein the levels of all individual elements other than iron, carbon and oxygen do not exceed 0.2 wt. %.

11. The process according to claim 10, wherein the dried iron powder is decarburized to reduce the level of carbon and oxygen.

12. The process according to claim 11, wherein the levels of all individual elements other than iron, carbon and oxygen do not exceed 0.1 wt. %.

13. The process according to claim 12, wherein the total levels of all individual elements other than iron, carbon and oxygen in said iron powder granules do not exceed 0.4 wt. %.

14. The process according to claim 11, wherein said contaminant is a chlorinated solvent.

15. The process according to claim 14, wherein said contaminant plume is wastewater.

16. The process according to claim 14, wherein said contaminant is a contaminant plume, and said volume of iron powder granules are placed in the ground at least partially downgradient of said contaminant plume.

17. The process according to claim 16, wherein said contaminant plume is groundwater.

18. A contaminated site, comprising:
a chamber and a contaminant plume comprising a volatile organic compound, both said chamber and said contaminated plume being located in soil, at least a portion of said contaminant plume being upgradient of said chamber;
said chamber containing a volume of iron powder granules, the iron powder granules being water atomized by a process comprising granulating liquid iron by striking a stream of molten iron with water jets, and drying the resulting iron powder, said iron powder granules comprising iron, carbon and oxygen, wherein said oxygen is contained in said granules at from 1 to 6 wt. %; and
said contaminant plume passing through said iron powder granules, whereby said contaminant is remediated therefrom.

19. The contaminated site according to claim 18, wherein said iron powder granules have an average particle size of from 10 μm to 10 mm.

20. The contaminated site according to claim 19, wherein said carbon is contained in said granules at from 0.25 to 4 wt. %.

21. The contaminated site according to claim 20, wherein said iron powder granules have an average particle size of from 45 μm to 5 mm.

22. The contaminated site according to claim 21, wherein said carbon is contained in said granules at from 1 to 4 wt. %.

23. The contaminated site according to claim 22, wherein said oxygen is contained in said granule at from 2.5 to 6 wt. %.

24. The contaminated site according to claim 23, wherein said oxygen is contained in said granule at 2.5 to 3.5 wt. %.

25. The contaminated site according to claim 24, wherein said iron powder granules have an average particle size of from 100 μm to 5 mm.

26. The contaminated site according any one of claims 22 to 25, wherein the levels of all individual elements other than iron, carbon and oxygen do not exceed 0.2 wt. %.

27. The contaminated site according to claim 26, wherein the dried iron powder is decarburized to reduce the level of carbon and oxygen.

28. The contaminated site according to claim 27, wherein the levels of all individual elements other than iron, carbon and oxygen do not exceed 0.1 wt. %.

29. The contaminated site according to claim 28, wherein the total levels of all individual elements other than iron, carbon and oxygen in said iron powder granules do not exceed 0.4 wt. %.

30. The contaminated site according to claim 27, wherein said contaminant is a chlorinated solvent.

31. The contaminated site according to claim 30, wherein said contaminant plume is wastewater.

32. The contaminated site according to claim 30, wherein said contaminant plume is groundwater.

33. Iron powder granules comprising iron, carbon and oxygen, the iron powder granules being water atomized by a process comprising granulating liquid iron by striking a stream of molten iron with water jets and drying the resulting iron powder, wherein said carbon is contained in said granules at from 1 to 4 wt. % and said oxygen is contained in said granules at from 1 to 6 wt. %; said iron powder granules having an average particle size of from 10 μm to 10 mm.

34. The iron powder granules process according to claim 33, wherein said iron powder granules have an average particle size of from 45 μm to 5 mm.

35. The iron powder granules according to claim 34, wherein said oxygen is contained in said granule at from 2.5 to 6 wt. %.

36. The iron powder granules according to claim 35, wherein said oxygen is contained in said granule at 2.5 to 3.5 wt. %.

37. The iron powder granules according to claim 36, wherein said iron powder granules have an average particle size of from 100 μm to 5 mm.

38. The iron powder granules according any one of claims 33 to 37, wherein the levels of all individual elements other than iron, carbon and oxygen do not exceed 0.2 wt. %.

39. The iron powder granules according to claim 38, wherein the dried iron powder is decarburized to reduce the level of carbon and oxygen.

40. The iron powder granules according to claim 39, wherein the levels of all individual elements other than iron, carbon and oxygen do not exceed 0.1 wt. %.

41. The iron powder granules according to claim 40, wherein the total levels of all individual elements other than iron, carbon and oxygen in said iron powder granules do not exceed 0.4 wt. %.
